(19) United States
(12) Patent Application Publication
(10) Pub. No.: US 2003/0194418 A1
(43) Pub. Date: Oct. 16, 2003

(54) Livestock treatment capsule and method for applying a livestock treatment capsule

(76) Inventor: Donald George Hilton, Chappell Hill, TX (US)

Correspondence Address: Donald G. Hilton, P. O. Box 534, Chappell Hill, TX, 77426, US

(21) Appl. No.: 10/121,231

(22) Filed: Apr. 12, 2002

(51) Int. Cl. A01N 25/34

(52) U.S. Cl. 424/408

(57) ABSTRACT

A treatment capsule (10) comprising an outer membrane (11), an inner volume (12), and a topical treatment that fills the inner volume (11). In some embodiments, the treatment capsule (10) contains a pesticide for livestock. The method of selecting an animal, determining a dosage to be administered, determining the number of capsules to be administered, and propelling the number of treatment capsules at the selected animal.

### TECHNICAL FIELD OF THE INVENTION

This invention relates to treating livestock for pests. More particularly, the invention describes a breakable capsule used to deliver a topical chemical treatment to livestock. The invention encompasses a breakable capsule filled with a chemical treatment. The capsule is propelled at a selected animal, causing the capsule to break on the skin of the animal, thus delivering the topical treatment. The invention also encompasses a method for delivering the breakable treatment capsule.

### BACKGROUND OF THE INVENTION

One problem encountered in raising livestock is the presence of pests. These pests, such as insects, ticks, and worms, are attracted to livestock for various reasons. One reason is that livestock provide a good environment for pests to lay eggs. Pests lay eggs both in animal feces and directly on animals by embedding eggs in the skin of an animal. Another reason pests are attracted to livestock is because livestock provide a good host for parasites. Parasitic pests attach themselves to livestock and suck various fluids, such as blood, from the animals they infest.

When pests infest livestock, they create many significant problems that result in economic loss for livestock producers. The most common problem is the irritation of the animals, which causes constant movement, tail swinging, scratching, and rubbing. These movements by the livestock unnecessarily expends energy and causes a decrease in the growth potential and weight gains of the animals, thereby decreasing the yield of the livestock producer. The animal movement caused by pests creates several other problems for livestock producer, including increase in difficulty of handling, decrease in breeding activity, and a degradation in the overall health and sanitary conditions surrounding the livestock.

Parasitic and biting pests cause particular problems relating to livestock. First, parasitic of pests are known to spread infectious diseases among livestock. Livestock producer encounter economic loss due to the cost of treatment related to diseases and due to animals that die or are otherwise affected by disease. Second, when a pest bites or otherwise punctures the skin of an animal, the skin becomes damaged. The damage results in a lower value for the animal's hide, which may be used for leather.

One technique to eliminate pests is to spread a powder designed to kill larvae in the stable area. The animals are either allowed to migrate into the stable, or they are herded into the stable, so that the animals are exposed to the pesticide.

Other common methods for eliminating pests involve liquid chemicals. The chemicals are designed to repel pests, kill the pests or their larva or eggs, or in some other way disrupt the breeding cycle of the pests. Application techniques include mixing the chemicals with food and applying the chemicals by spraying, pouring, or rubbing them directly onto the animals.

One technique for applying a chemical treatment to animals is described in U.S. Pat. No. 6,216,639 to Simmons et. al. A self-medicating applicator device is placed near a feeding location for livestock or wildlife. The device holds a liquid that can be transferred onto an animal when the animal comes into contact with the device. The device is located near a feeding location so that when an animal comes to feed, it rubs against the device and the treatment is applied to the animal at the contact point.

Yet another method uses a hose with a specialized nozzle. The nozzle is designed spray a pre-determined amount of treatment when triggered. This method allows a producer to discharge a specified dosage every time the nozzle is triggered. It also allows the producer the ability to spray each animal individually.

### SUMMARY OF THE INVENTION

The present invention includes a treatment capsule comprised of an outer membrane, an inner volume, and a topical treatment that fills the inner volume.. Each capsule has an outer membrane that is designed to break when it strikes a solid object. In some embodiments, each breakable capsule includes a color marker for temporarily marking the animal the target.

The method according to the invention includes selecting an animal to be treated and determining the dosage of treatment to be applied to the selected animal. The number of capsules to be administered is determined by the volume of treatment in each capsule and the dosage to be administered to the selected animal. The method then includes propelling a number of breakable capsules at the selected animals.

These and other objects, advantages, and features of the invention will be apparent from the following description of the preferred embodiment, when considered with the accompanying drawings.

### BRIEF DESCRIPTION OF THE DRAWINGS

FIG. 1 is a view in section of the breakable treatment capsule.

FIG. 2 is a diagram showing the application of a breakable treatment capsule from a remote location.

FIG. 3 is a flow chart showing the method according to the invention.

### DESCRIPTION OF THE PREFERRED EMBODIMENT

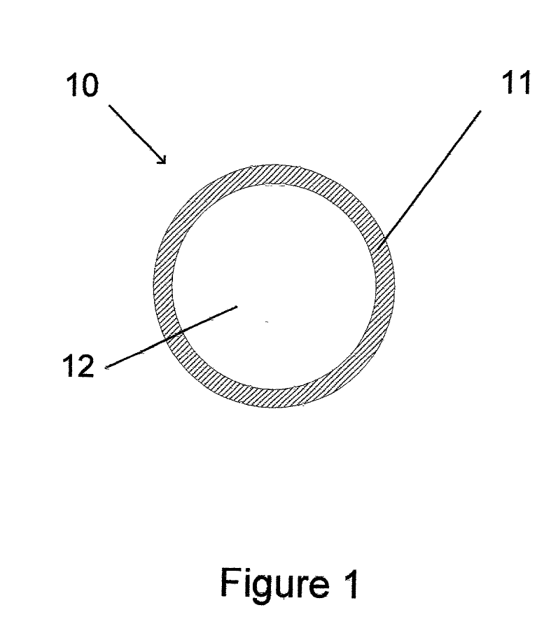

FIG. 1 shows a cross-section of the treatment capsule 10 according to one embodiment of the invention. The capsule 10 is comprised of a substantially spherical outer membrane 11 and an inner volume 12 that is enclosed by the outer membrane 11. The inner volume contains a topical treatment. In some embodiment, the topical treatment is a treatment for livestock. In one of the preferred embodiments, the treatment is a pesticide for livestock, particularly for cattle.

The capsule 10 is constructed so it breaks when it impacts a solid object with sufficient velocity. In some embodiments, the solid object is livestock. Capsule 10 can be constructed of gelatin, a polymer such as polystyrene, or any material that will break when it strikes a solid object with sufficient velocity. In this disclosure, sufficient velocity is a velocity great enough to cause the capsule to break when it impacts a solid object. Preferably, however, the velocity of the capsule is not so great so as to cause the capsule to break before it strikes to selected animal, nor is it so great so as to damage or bruise the animal's hide. When the capsule strikes an animal, it breaks and deposits the topical treatment onto the animal's hide. A similar capsule is described in U.S. Pat. No. 4,656,092 to Haman et al., relating to a paint ball used in a recreational war game.

In one embodiment, the breakable capsule is further comprised of a biodegradable substance. After use, the used remainder of the capsule will degrade. In yet another embodiment, the breakable capsulate is further comprised of a photo-degradable additive. The capsules must be protected from light when stored. After use, sunlight will activate the photo-degradable additive, and the remainder of used capsules will degrade.

The volume of the inner volume 12 can be determined based on the dosage amounts required by the animals to be treated. The following example is intended to be illustrative and is not intended to limit the invention. If a group of animals is comprised of calves, yearlings, and full grown animals, the correct dosage will vary based on the size of the particular animal to be treated. For a particular chemical, the treatment dosage may be 5 ml for a calf, 10 ml for a yearling, and 15 ml for a full grown animal. By selecting a volume of 5 ml for inner volume 12, the correct number of capsules to be administered will be one capsule for a calf, two capsules for a yearling, and three capsules for a full grow animal. Using only one size for capsule 10 allows the use of only one device for propelling the capsules.

In some embodiments, inner volume 12 contains a small amount of a temporary color marker along with the treatment. By including such a marker in inner volume 12, the marker is deposited on the target animal when capsule 10 breaks. The marker creates a colored mark on the target animal indicating that the animal has received a treatment capsule. Advantageously, this allows easy identification of the animals that have already been treated and the amount of treatment that has been administered to those animals. The marker can be comprised of temporary ink, water-soluble vegetable die, or other suitable material that will leave a colored mark when a capsule is administered and then fade within about a few days. Preferably, the marker is environmentally safe and non-toxic.

In one embodiment, the marker is comprised of luminescent material. A luminescent material gives off light making it easier to visually observe a marker that has been deposited on an animal, and it allows the capsule to be used at night. A recreational paint-ball containing luminescent material is described in U.S. Pat. No. 5,001,880 to Smith.

The device used to propel the capsules at animals can be any device that generates enough velocity so that the capsules will travel the distance between the device and the target animal and still have sufficient velocity to cause the capsule to break when it strikes the target animal, without breaking the capsule before impact. One such device is a pneumatically operated gun, such as the one described in U.S. Pat. No. 4,819,609 to Tippmann. Optionally, a pneumatic gun can include a container to hold a number of breakable capsules that is adapted to load a new capsule into pneumatic gun after each firing. One such device is described in U.S. Pat. No. 5,097,816 to Miller. Many different devices will be apparent to one skilled in the art, including a sling shot, a bow-type device, or any device or method that will deliver the breakable capsule with a sufficient velocity. The specific device used to propel the capsules is not part of the present invention.

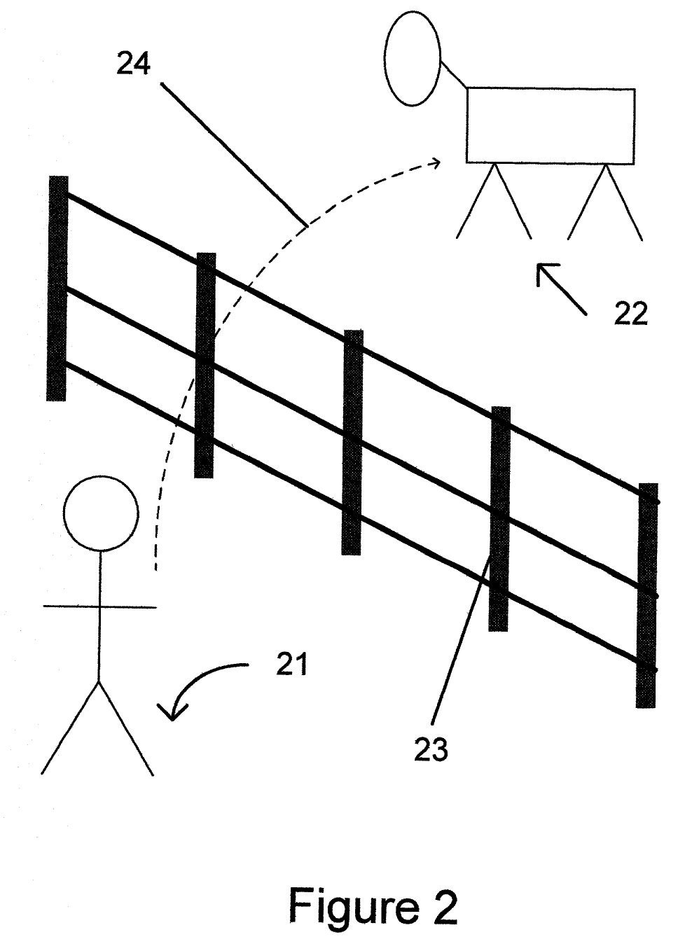

One of the preferred embodiments is shown in FIG. 2. A person stands at the administration point 21 and propels a capsule at a selected animal at target point 22. The administration point 21 is on the opposite side of a fence 23 from the target point 23, and the capsule travels along path 24 from the administration point 21 to the target point 22.

The breakable capsule according to the present invention presents advantages over the prior art. The treatment capsules can be administered to animals as they graze, eat, or sleep, thus there is no need to herd or move animals when administering the treatment. Advantageously, the animals are not required to move and expend extra energy resulting in decreased yield. Also, a specific dosage can be applied to each animal, and the dosage can be selected based on each animal's needs. Advantageously, the dosage administered to each animal is known. Further, the breakable capsule according to the invention can be administered from a distance without treatment falling to the ground between the administration point and the target point. This distance also prevents the animals from becoming agitated by human proximity.

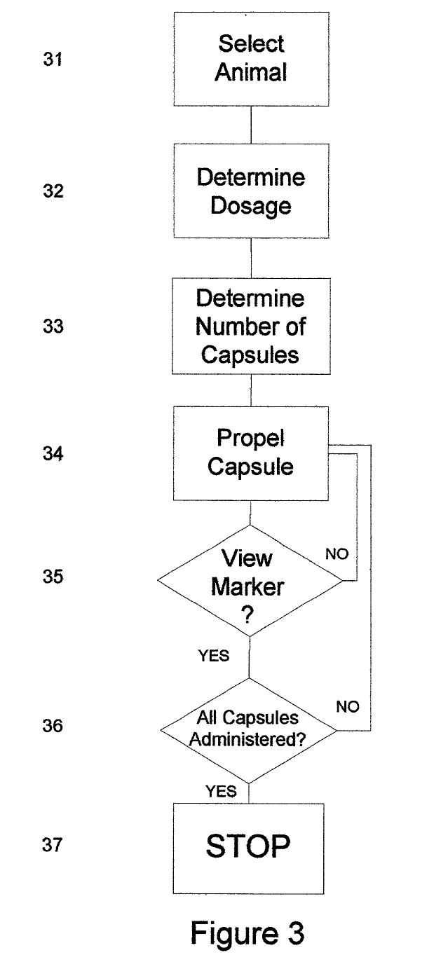

The method according to the invention can be described with reference to FIG. 3. First, an animal to be treated is selected 31. Then, a treatment dosage is determined 32. It is not important in which order these are performed. For example, dosage can be determined before an animal is selected, and then the animal can be selected based on ease of application. In some embodiments, the dosage is selected based on the size and treatment needs of the animal that was selected. As described above, certain size cattle require different dosages. For example, the dosages for a particular treatment may be 5 ml for a calf, 10 ml for a yearling, and 15 ml for a full grown animal. Once the dosage for the selected animal has been determined, the method next includes determining the number capsules to be administered to the selected animal 33. Using the example above, if the capsule contains a volume of 5 ml, the number of capsules would be one for a calf, two for a yearling, and three for a full grown animal.

The method next includes propelling at least one breakable treatment capsule at the selected animal 34. The methods and devices for propelling the capsule were described above and are not part of the present invention. Next, the method requires determining if the capsule was successfully administered to the selected animal 35. A capsule is successfully administered if it breaks on the selected animal resulting in the treatment being deposited on the animal. In a preferred embodiment, this step is accomplished by visually determining if a color marker in the capsule was deposited on the selected animal. If it is determined that the capsule did not break on the selected animal, the method requires repeating the propelling of a capsule at the selected animal until a capsule is successfully administered. Once a capsule is successfully administered, it must be determined if the number of capsules to be administered have been administered 36. For example, if a yearling requires two capsules to be administered and the yearling had one color maker showing on its skin, the yearling requires one more capsule to be administered. If it is determined that at least one more treatment capsule must still be administered, another treatment capsule must be propelled at the selected animal. If the it is determined that the correct number of capsules have been applied 46, then the treatment for the selected animal is stopped 37. The method may then be repeated for a plurality of other animals.

The above described preferred embodiments are intended to illustrate the principles of the invention, but not to limit the scope of the invention. Various other embodiments and modifications to these preferred embodiments may be made by those skilled in the art without departing from the scope of the following claims.

1. A treatment capsule comprising:
(a) an outer membrane adapted to break when, with sufficient speed, the treatment capsule strikes a solid object;
(b) an inner volume enclosed by the outer membrane; and
(c) a topical treatment that fills the inner volume.

2. The treatment capsule of claim 1 wherein the topical treatment is a treatment for livestock.

3. The treatment capsule of claim 2 wherein the topical treatment is a pesticide.

4. The treatment capsule of claim 3 wherein the livestock are cattle.

5. The treatment capsule of claim 1 wherein the inner volume is about 5 milliliters.

6. The treatment capsule of claim 1 wherein the topical treatment contains a color marker.

7. The treatment capsule of claim 6 where in the color marker is a water-soluble vegetable dye.

8. The treatment capsule of claim 1 wherein the outer membrane is comprised of gelatin.

9. The treatment capsule of claim 8 wherein the outer membrane is further comprises a photo-degradable additive.

10. The method of treating livestock comprising:
(a) selecting an animal for treatment;
(b) determining the dosage of a topical treatment to be administered to the selected animal;
(c) determining a number of respective breakable treatment capsules to be administered based on a volume of topical solution in each respective breakable treatment capsule and a total amount of topical treatment to be applied to the selected animal; and
(d) administering the treatment by propelling the determined number of respective breakable treatment capsules at the selected animal with sufficient velocity to cause each respective breakable treatment capsules to break on the selected animal and deposit the topical solution.

11. The method of claim 10 wherein the topical solution is a pesticide to reduce pests on livestock.

12. The method of claim 10 wherein administering the treatment comprises:
(a) propelling a respective breakable treatment capsule at the selected animal;
(b) determining if the respective breakable treatment capsule was successfully administered; and
(c) administering an additional respective breakable treatment capsule for each administered treatment capsule that is not successfully administered.

13. The method of claim 12 wherein each respective breakable treatment capsule contains a color marker that marks the selected animal if the respective treatment capsule strikes the selected animal and determining if each respective capsule was successfully administered is accomplished by observing whether or not the color marker was applied to the selected animal.

14. The method of claim 13 further comprising:
(a) determining a total number of respective breakable treatment capsules that have been successfully administered;
(b) if the total number of successfully administered respective breakable treatment capsules is less than the determined number of respective breakable treatment capsules to be administered, administering another respective treatment capsule;
(c) continuing to administer respective breakable treatment capsules until the total number of number of successfully administered respective breakable treatment capsules is equal to the determined number of respective breakable treatment capsules to be administered; and
(d) stopping treatment with respect to the selected animal.

15. The method of claim 10 wherein propelling each respective breakable capsule is accomplished using a pneumatic gun.

16. The method of treating livestock comprising:
(a) selecting an animal for treatment;
(b) determining the dosage of a pesticide to be administered to the selected animal;
(c) determining a number of respective breakable treatment capsules to be administered based on a volume of topical solution in each respective breakable treatment capsule and a total amount of topical treatment to be applied to the selected animal, each respective breakable treatment capsule containing the pesticide;
(d) propelling a respective breakable treatment capsule at the selected animal using a pneumatic gun;
(e) determining if the respective breakable treatment capsule was successfully administered by observing if a colored marker in the respective breakable treatment capsule was deposited on the selected animal;
(f) administering an additional treatment capsule for each administered treatment capsule that is not successfully administered.
(g) determining a total number of respective breakable treatment capsules that have been successfully administered;
(h) if the total number of successfully administered respective breakable treatment capsules is less than the determined number of respective breakable treatment capsules to be administered, administering another respective treatment capsule;
(i) continuing to administer respective breakable treatment capsules until the total number of number of successfully administered respective breakable treatment capsules is equal to the determined number of respective breakable treatment capsules to be administered; and
(j) stopping treatment with respect to the selected animal.

17. The method of claim 16 wherein the method is performed on a plurality of animals.
